(19) United States
(12) Patent Application Publication
(10) Pub. No.: US 2025/0061896 A1
(43) Pub. Date: Feb. 20, 2025

(54) USE OF NON-AUDIBLE SILENT SPEECH COMMANDS FOR AUTOMATED ASSISTANTS

(71) Applicant: GOOGLE LLC, Mountain View, CA (US)

(72) Inventor: Glen Shires, Danville, CA (US)

(21) Appl. No.: 18/235,241

(22) Filed: Aug. 17, 2023

(51) Int. Cl. G10L 15/24; G06F 21/32; G10L 15/18; G10L 15/20; G10L 15/22

(52) U.S. Cl. CPC G10L 15/24; G06F 21/32; G10L 15/1815; G10L 15/20; G10L 15/22; G10L 2015/223

(57) ABSTRACT

Implementations can determine whether to activate non-audible silent speech recognition for using non-audible speech commands to an automated assistant. This can include detecting non-audible silent speech data based on one or more non-audible sensors, and, optionally, detecting temporally corresponding audible data based on one or more audible sensors. Recognized text based can then be generated based on processing the non-audible silent speech data and then one or more actions can be performed or one or more fulfillments initiated based on the non-audible silent speech data.

### BACKGROUND

Humans can engage in human-to-computer dialogs with interactive software applications referred to herein as “automated assistants” (also referred to as “digital agents,” “interactive personal assistants,” “intelligent personal assistants,” “assistant applications,” “conversational agents,” etc.). Humans (which when they interact with automated assistants may be referred to as “users”) typically provide commands and/or requests to an automated assistant using spoken natural language input (i.e., utterances), which may in some cases be converted into text and then processed, and/or by providing textual (e.g., typed) natural language input. An automated assistant responds to a request by providing responsive user interface output, which can include audible and/or visual user interface output.

For various automated assistants, a user must explicitly invoke an automated assistant before the automated assistant will fully process a spoken utterance. The explicit invocation of an automated assistant typically occurs in response to certain user interface input being received at a client device, where the certain user interface input is in addition to the spoken utterance itself. For example, the certain user interface input can precede the spoken utterance and can be an explicit invocation, such as speaking of a hot word/wake word/invocation phrase, actuation of a hardware element, actuation of a graphical user interface element, performing a touch-free gesture, or other user interface input that is in addition to the spoken utterance itself and that, when detected, causes the automated assistant to process the spoken utterance. Such explicit invocations can prolong the duration of a user's interaction with an automated assistant and can require additional processing resources to be utilized (e.g., in processing corresponding data in determining whether an explicit invocation is present).

The client device includes an assistant interface that provides, to a user of the client device, an interface for interfacing with the automated assistant (e.g., receives input from the user, and provides audible and/or graphical responses), and that interfaces with one or more additional components that implement the automated assistant (e.g., on-device component(s) and/or remote server device(s) that process user inputs and generate appropriate responses).

As mentioned above, many automated assistants are configured to be interacted with via spoken utterances. However, there may be instances where a user speaking out loud in interacting with the automated assistant is undesirable. Some such instances, without limitation, may include: noisy environments where spoken utterances may be difficult for an automated assistant to recognize accurately; environments, such as theaters, where it would disturb others to speak aloud; environments where there is another conversation occurring and a user may not want to interrupt or disturb that conversation; and/or environments where privacy of a user is a consideration.

### SUMMARY

Many client devices that facilitate interaction with automated assistants—also referred to herein as “assistant devices”—enable users to engage in touch-free interaction with automated assistants. For example, assistant devices often include microphones that allow users to provide vocal utterances to invoke and/or otherwise interact with an automated assistant. Assistant devices described herein can additionally or alternatively incorporate, and/or be in communication with, one or more non-audible sensors, such as various vision components (e.g., camera(s)), Light Detection and Ranging (LIDAR) component(s), radar component(s), etc.), accelerometers, magnetometers, gyroscopes, ultrasound, and/or electromyography, to facilitate touch-free and/or silent interactions with an automated assistant.

Implementations disclosed herein relate to recognition of non-audible silent speech (e.g., where a user “mouths” or “lips” words without audible spoken words) and adaptation of one or more function(s) of an automated assistant based thereon. Such implementations may include determining whether to activate non-audible speech recognition that is based at least in part on the non-audible silent speech data and/or determining whether to perform action(s) and/or initiate fulfillment(s) based on any recognized text from non-audible speech recognition. The non-audible silent speech data, that is processed in performing non-audible speech recognition, can be based on one or more non-audible sensors, such as, for example, one or more cameras, accelerometers, magnetometers, ultrasound, and/or gyroscopes. The non-audible sensors may be able detect silent and/or subvocal speech of a user, for example by detecting tongue, lip, and/or larynx movement.

In some implementations, determining whether to activate the non-audible speech recognition, and/or perform action(s) and/or initiate fulfillment(s) based thereon, can include comparing the non-audible silent speech data with audible data collected by the client device. This audible data can be based upon one or more audible sensors, such as one or more microphones. This comparison allows for determining if there is correspondence between the non-audible silent speech data and the audible data (e.g., is the “silent speech” truly silent or does the “silent speech” overlap with audible data).

Various implementations disclosed herein seek to activate non-audible silent speech recognition, and/or at least selectively perform action(s) and/or initiate fulfillment(s) based thereon, when it is determined that there is not correspondence between the non-audible silent speech data and the audible data (i.e., it is truly silent speech). Further, some of those various implementations seek to at least selectively not perform any speech recognition, and/or not perform any action(s) and/or fulfillment(s) based on any speech recognition, when it is determined that the is a correspondence between the non-audible silent speech data and the audible data. Accordingly, those various implementations can enable full processing of silent speech while suppressing full processing of audible speech in various situations. For example, at least in certain situations full processing of audible speech can be suppressed unless such audible speech is preceded by an explicit invocation (e.g., speaking of a wake word, actuation of a hardware or software button for an assistant, etc.), while full processing of non-audible silent speech can be enabled. In these and other manners, implementations enable a user to engage with an automated assistant through silent speech, while preventing any engagement with the automated assistant when audible speech is instead provided. Moreover, those implementations can enable engagement through silent speech without requiring any explicit invocation be provided prior to (or after) the silent speech, thereby shortening the duration of the interaction with the automated assistant.

Determining whether there is correspondence between non-audible silent speech data and audible data can be performed in a variety of ways. For example, in some implementations, determining whether non-audible silent speech data and audible data correspond may be achieved by comparing phonemes detected based on each. Phonemes can be classified as distinct units of sound that allow for words that can be distinguished from each other. For example, in English the “p”, “b”, “d”, and “t” in the words “pad”, “pat”, “bad”, and “bat”. In some additional or alternative implementations, determining whether non-audible silent speech data and audible data correspond may be achieved by determining if the non-audible silent speech and audible data include one or more features of temporal correspondence, for example whether they overlap in the time they were spoken or uttered. In still other implementations, determining whether non-audible silent speech data and audible data correspond may be achieved by determining that there is a lack of correspondence based on a lack of voice activity detection based on the audible data.

In response to determining that there is a lack of correspondence between non-audible silent speech data and audible data, the client device may determine whether to activate the non-audible speech recognition. This includes determining the contents of the non-audible silent speech and generating recognized text based on the non-audible silent speech data. This recognized text is processed, and one or more actions are performed, or one or more fulfillments initiated based on the non-audible silent speech data.

In some implementations, the performing one or more actions or initiating one or more fulfillments based on the non-audible silent speech may include determining, based on the recognized text for the non-audible silent speech data, whether to activate natural language understanding or activate fulfillment that is based on the natural language understanding. If natural language understanding is activated, one or more actions may be performed, or one or more fulfillments initiated. In some implementations, the silent speech data may be processed using a trained silent speech model to generate the recognized text. Some such requests/commands may include actions that a user wants to perform without being intrusive to others by using audible speech. For example, requests/commands such as: “stop video”, “zoom in”, “transfer call”, etc.

In some implementations, determining whether to activate the non-audible speech recognition includes determining if an audible wake word is spoken by a user, and if so, generating recognized text from the audible speech following the wake word. This would allow for a user to provide an audible command to the assistant with the use of a wake word. This use of an audible wake word may be either in addition to, or in the alternative to, a user's silent speech command to the assistant.

In some implementations, silent speech techniques disclosed herein can be performed only when a silent mode is activated. For example, in some implementations, there may be a determination of whether a silent mode is activated, and one or more silent speech techniques performed only when the silent mode is determined to be activated. For example, determining whether there is correspondence between non-audible silent speech data and audible data can be performed only when the silent mode is activated and/or performing non-audible speech recognition (e.g., in response to determining lack of correspondence) can be performed only when the silent mode is activated. Activation of a silent mode may be through user input. For example, a first user input (e.g., interaction with a silent mode GUI element) can be provided to activate the silent mode and the silent mode can remain active until a second user input is provided to deactivate the silent mode (e.g., an additional interaction with the silent mode GUI element). As another example, user input(s) can be used to define location(s) at which, and/or time(s) during which, the silent mode should be active. Activation of silent mode can additionally or alternatively be automated (i.e., not requiring any user input(s) to activate), for example when the client device detects that it is in a particularly noisy environment (e.g., a threshold level of noise, optionally for a threshold duration), where picking up an audible command may be difficult. In another example, silent mode can be automatically activated in response to determining that the client device is located at a particular geographical location (e.g., a geographic location of a particular type, such as a movie theater, opera, etc.). In some instances, the user is provided with a feedback signal to indicate that a silent mode has been activated, for example an auditory signal, a visual signal, a haptic signal, and/or other user perceivable signal(s).

With audible speech, the client device may be able to authenticate a user (in some instances from a selection of known users) by voice. However, similar voice-based authentication capabilities may not be available for silent speech. Accordingly, in some implementations, a client device may need to authenticate that the user is actively utilizing the client device prior to fully processing non-audible silent speech. This authentication can be, in some implementations, through one or more user inputs (e.g., entry of a pin, passcode, password, or the like). In other implementations, the authentication can additionally or alternatively be through confirmation of some biometric data point (e.g., fingerprint, face scan, retinal scan, or the like). In still other implementations, the authentication can be can additionally or alternatively achieved through one or more other non-audible sensors, such as a camera, accelerometer, a magnetometer, and/or a gyroscope, which may, for example, be able to be determined by the positioning of the client device. In some implementations, the silent mode can be automatically transitioned into an active state while the user authentication is active.

The above description is provided as an overview of some implementations of the present disclosure. Further description of those implementations, and other implementations, are described in more detail below.

### BRIEF DESCRIPTION OF THE DRAWINGS

FIG. 1A depicts an example process flow that demonstrates various aspects of the present disclosure, in accordance with various implementations.

FIG. 1B is a block diagram of an example environment that includes various components from FIG. 1A, and in which implementations disclosed herein can be implemented.

FIG. 2 depicts a flowchart illustrating an example method according to implementations disclosed herein.

FIG. 3 illustrates an example architecture of a computing device.

### DETAILED DESCRIPTION

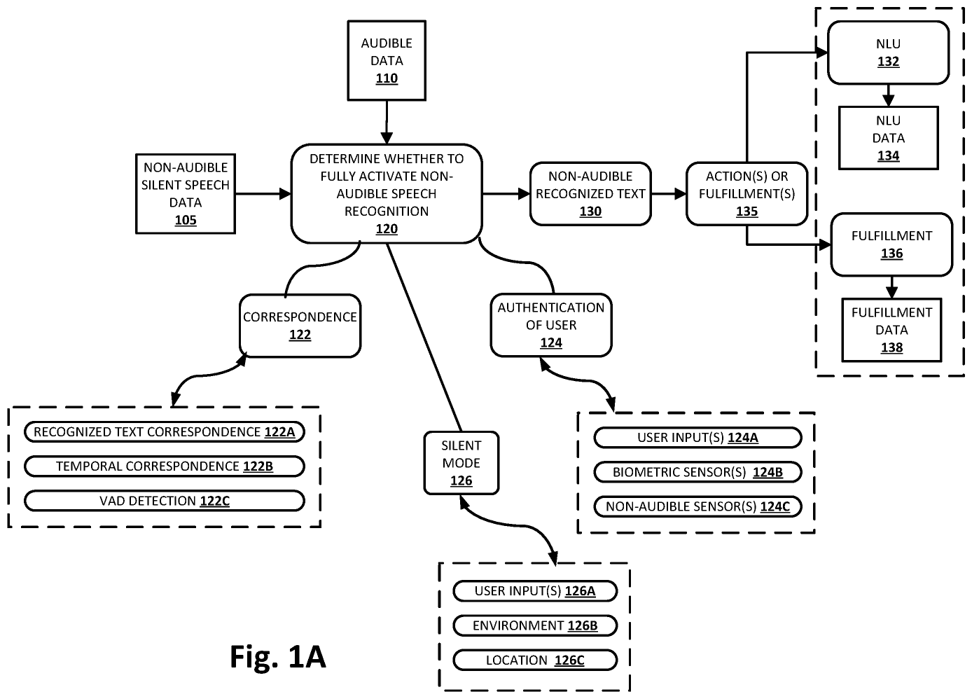

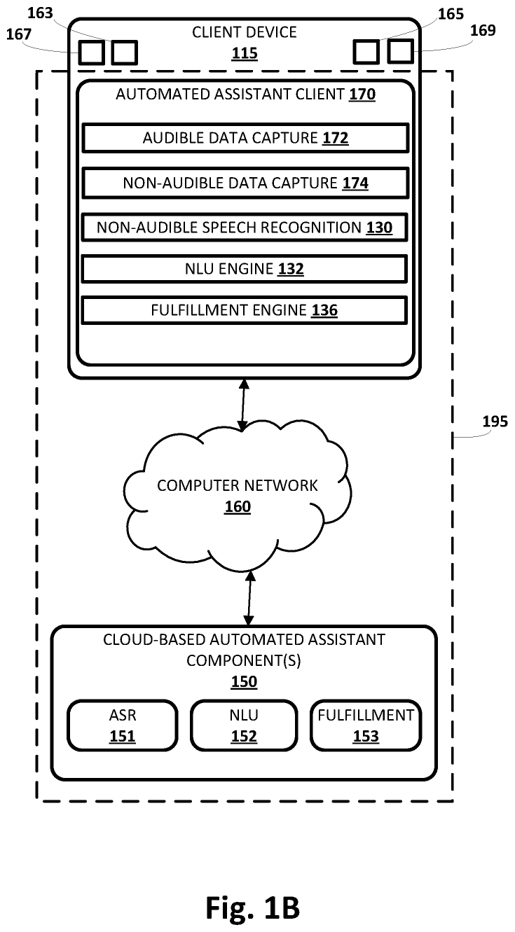

Turning initially to FIG. 1A, an example process flow is illustrated that demonstrates various aspects of the present disclosure, in accordance with various implementations. The components illustrated in FIG. 1A can be implemented on client device 115 (FIG. 1B). In FIG. 1A, the client device detects and/or receives non-audible silent speech data 105 from one or more non-audible sensors (e.g., 163 of FIG. 1B) of the client device. The client device may also, although not necessarily, detect and/or receive audible data 110 that is detected via one or more audible sensors (e.g., one or more microphones (165, FIG. 1B)) of the client device. The non-audible silent speech data 105 received from the non-audible sensor(s) (e.g., 163 of FIG. 1B) can be raw sensor data and/or representation and/or abstraction thereof (e.g., abstraction provided by the operating system of the client device 115). The non-audible silent speech data (and audible data, if utilized) can be provided in a streaming fashion as new sensor data is detected. The non-audible sensor(s) can include, for example, camera(s), Light Detection and Ranging (LIDAR) component(s), radar component(s), accelerometers, magnetometers, gyroscopes, ultrasound, and/or electromyography, each of which, alone or in combination, can facilitate touch-free and/or silent interactions with an automated assistant or client device. Where audible data 110 is detected or received by the client device, the audible data 110 can likewise include the raw audible data, and/or a representation thereof. The audible data 110 can be provided in a streaming fashion as new audible data is detected.

A determination of whether to fully activate non-audible speech recognition 120 can be made based on processing of the non-audible silent speech data 105 and/or the audible data 110.

In some implementations, determining whether to fully activate non-audible speech recognition 120 is based on determining whether there is a correspondence 122 between the audible data 110 and the non-audible silent speech data 105. Determination of correspondence may be achieved through a variety of mechanisms. In one example, the determination of correspondence can be achieved by comparing the audible data with the non-audible silent speech data 122A. For example, in some implementations, the audible data 110 is processed using a speech recognition model (not illustrated in FIG. 1A for simplicity) to determine audible recognized text (if any) captured by the audible data 110. This process is repeated for the non-audible silent speech data 105, which is processed by a non-audible silent speech recognition model (not illustrated in FIG. 1A for simplicity) to determine non-audible recognized text 130 (if any) from the non-audible silent speech data 105. Determining whether there is correspondence between the audible data 110 and the non-audible silent speech data 105 can include, although is not limited to, a comparison of one or more phonemes determined from the non-audible silent speech data 105 with one or more phonemes determined from audible data 110. Phonemes may be classified as distinct units of sound that allow for words that can be distinguished from each other. For example, in English the “p”, “b”, “d”, and “t” in the words “pad”, “pat”, “bad”, and “bat”. Although illustrated and described herein as occurring prior to the determination of correspondence 122, fully processing and/or determining the non-audible recognized text 130 is not so limited. In some implementations, determining the non-audible recognized text 130 may occur following the determination of whether to activate non-audible speech recognition 120 is made.

In another example, determining whether there is correspondence between the non-audible silent speech data 105 and the audible data 110 may include determining that there is a lack of correspondence based on a lack of voice activity detection (VAD) based on the audible data 110. For example, a voice-activity detection (VAD) module 122C can be utilized to process audible data 110 and provide one or more metrics to the client device 115. The VAD module 122C processes audible data 110 to monitor for the occurrence of any audible human speech and can output a voice activity metric that indicates whether audible voice activity is present. The voice activity metric can be a binary metric, or a probability of there being audible human speech in the audible data. The VAD module 122C can optionally utilize a VAD model in processing audible data and determining whether voice activity is present. The VAD model can be a machine learning model trained to enable discrimination between audible data without any human utterances and audible data with human utterance(s). In some implementations or situations, the client device 115 can optionally fully activate the non-audible speech recognition engine 120 only when the VAD module 122C indicates voice activity. For example, where the VAD indicated no audible voice activity present fully process non-audible speech data; however, where the VAD indicates voice activity occurs during the same time period, the non-audible silent speech data is not fully processed.

In another example, determining whether there is correspondence between non-audible silent speech data and the audible data 122 can additionally or alternatively include determining whether there are one or more features of temporal correspondence between the non-audible silent speech data 105 and the audible data 110. In other words, a determination may be made as to whether the non-audible silent speech data and the audible data overlap in the time they were spoken or uttered. This allows for a determination of whether there is correspondence between the movement of the mouth, or silent speech, and the audible data. Such feature(s) of temporal correspondence can include the start time(s) of the non-audible silent speech data and/or the audible data being within a predefined threshold; similarly, the feature(s) of temporal correspondence can include the end time(s) of the non-audible silent speech data and the audible data being within a predefined threshold. The one or more features of temporal correspondence can also include an evaluation of the phoneme(s) in common between the non-audible silent speech data and the audible data.

In some of these various implementations, the client device 115 can seek to at least selectively not perform any speech recognition, and/or not perform any action(s) and/or fulfillment(s) based on any speech recognition, when it is determined that there is a correspondence between the non-audible silent speech data and the audible data 122. Accordingly, in these various implementations, full processing of non-audible silent speech data 105 can be enabled while suppressing full processing of audible data 110 in various situations. For example, at least in certain situations full processing of audible speech can be suppressed unless such audible speech is preceded by an explicit invocation (e.g., speaking of a wake word, actuation of a hardware or software button for an assistant, etc.), while full processing of non-audible silent speech can be enabled. In these and other manners, implementations enable a user to engage with an automated assistant through silent speech, while preventing any engagement with the automated assistant when audible speech is instead provided. Moreover, those implementations can enable engagement through silent speech without requiring any explicit invocation be provided prior to (or after) the silent speech, thereby shortening the duration of the interaction with the automated assistant.

In some implementations, determining to fully activate non-audible speech recognition 120 may include the client device 115 authenticating a user 124. This can include, for example, authenticating that the user is actively utilizing the client device 115 prior to processing non-audible silent speech. This authentication 124 can be, in some implementations, through one or more user inputs 124A (e.g., entry of a pin, passcode, password, or the like). In some additional or alternative implementations, this authentication 124 can be through confirmation of some biometric data point 124B (e.g., fingerprint, face scan, retinal scan, or the like). The authentication 124 can also be achieved through one or more non-audible sensors 124C, such as a camera, accelerometer, a magnetometer, and/or a gyroscope, which may, for example, be able to be determined by the positioning of the client device.

In some additional or alternative implementations, determining to fully activate non-audible silent speech recognition 120 is made is made by determining if a silent mode 126 has been activated. In some such implementations, only when silent mode 126 is activated will the non-audible recognized text 130 from the non-audible silent speech data 105 be processed. Activation of silent mode 126 may be manually done by one or more user input(s) 126A. This user input 126A may, for example, include switching the client device into silent mode with a button, pin input, gesture, etc. Activation of silent mode 126 can also be automated, for example when the client device 115 detects that it is in a particularly noisy environment 126B (e.g., a noisy restaurant, sporting event, etc.), where picking up an audible command via a microphone or the like can be difficult. In another example, silent mode 126 can be automatically activated when the client device is located at a particular predetermined geographical location 126C (e.g., a movie theater, opera, etc.). In some instances, the user is provided with a feedback signal to indicate that silent mode 126 has been activated, for example an auditory signal, a visual signal, a haptic signal, etc. In some instances, for example when a user has been authenticated 124, once the client device 115 has been placed into silent mode 126 the device can remain in silent mode 126 so long as the user authentication remains active.

In response to the determination to fully activate non-audible silent speech 120 one or more actions may be performed and/or one or more fulfillments may be initiated 135 based on the non-audible silent speech data 105. When the NLU engine 132 is activated, the NLU engine 132 performs natural language understanding on the non-audible recognized text 130 to generate NLU data 134. NLU engine 132 can optionally utilize one or more NLU models (not illustrated in FIG. 1A for simplicity) in generating the NLU data 134. NLU data 134 can include, for example, intent(s) that correspond to the spoken utterance and optionally parameter(s) (e.g., slot values) for the intent(s). In some implementations, the NLU engine 132 and associated processing of the non-audible recognized text 130 may be wholly contained on the client device 115, but this is not intended to be limiting. In additional or alternative implementations, the NLU engine 132 and associated processing of the non-audible recognized text 130 may be at least partially off the client device 115.

When the fulfillment engine 136 is activated, the fulfillment engine 136 generates fulfillment data 138, in some instances using the natural language understanding data 134. Fulfillment engine 136 can optionally utilize one or more fulfillment models (not illustrated in FIG. 1A for simplicity) in generating the fulfillment data 138. This fulfillment data 138 can define local and/or remote responses (e.g., answers) to the non-audible silent speech, interaction(s) to perform with locally installed application(s) based on the non-audible silent speech, command(s) to transmit to Internet-of-things (IoT) device(s) (directly or via corresponding remote system(s)) based on the non-audible silent speech, and/or other resolution action(s) to perform based on the non-audible silent speech. The fulfillment data 138 is then provided for local and/or remote performance/execution of the determined action(s) to resolve the non-audible silent speech. Execution can include, for example, rendering local and/or remote responses (e.g., visually and/or audibly rendering (optionally utilizing a local text-to-speech module)), interacting with locally installed applications, transmitting command(s) to IoT device(s), and/or other action(s).

Turning now to FIG. 1B, a block diagram is illustrated of an example environment that includes various components from FIG. 1A, and in which implementations disclosed herein may be implemented. The client device 115 at least selectively executes an automated assistant client 170. The term “assistant device” is also used herein to reference a client device 115 that at least selectively executes an automated assistant client 170. The automated assistant client 170 includes, in the example of FIG. 1B, a non-audible speech recognition engine 130, the NLU engine 132, and the fulfillment engine 136 described above with respect to FIG. 1A. The automated assistant client 170 further includes audible data capture engine 172 and non-audible data capture engine 174, described in more detail below.

One or more cloud-based automated assistant components 150 can optionally be implemented on one or more computing systems (collectively referred to as a “cloud” computing system) that are communicatively coupled to client device 115 via one or more local and/or wide area networks (e.g., the Internet) indicated generally at 160. The cloud-based automated assistant components 150 can be implemented, for example, via a cluster of high-performance servers.

In various implementations, an instance of an automated assistant client 170, by way of its interactions with one or more cloud-based automated assistant components 150, may form what appears to be, from a user's perspective, a logical instance of an automated assistant 195 with which the user may engage in a human-to-computer interactions (e.g., spoken interactions, non-audible silent speech interactions, gesture-based interactions, and/or touch-based interactions).

The one or more client devices 115 can include, for example, one or more of: a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker, a smart appliance such as a smart television (or a standard television equipped with a networked dongle with automated assistant capabilities), and/or a wearable apparatus of the user that includes a computing device (e.g., a watch of the user having a computing device, glasses of the user having a computing device, a virtual or augmented reality computing device). Additional and/or alternative client computing devices may be provided.

Client device 115 can be equipped with one or more non-audible sensors 163 to facilitate touch-free and/or silent interactions with an automated assistant. The non-audible sensor(s) 163 can take various forms, such as one or more vision components (e.g., monographic cameras, stereographic cameras, a LIDAR component (or other laser-based component(s)), a radar component, etc.), accelerometers, magnetometers, gyroscopes, ultrasound, and/or electromyography. The non-audible sensors 163 may be used, e.g., by non-audible data capture engine 174, to capture non-audible silent speech data 105 of an environment in which client device 115 is deployed. In some implementations. Additionally, among other things, these can be utilized to determine whether a user is present near the client device 115 and/or a distance of the user (e.g., the user's face) relative to the client device. Such determination(s) can be utilized by the client device 115 in determining whether to activate non-audible silent speech recognition engine 120.

Client device 115 can also be equipped with one or more microphones 165. Speech capture engine 172 can be configured to capture user's speech and/or other audible data 110 captured via microphone(s) 165. As described herein, such audible data 110 may optionally be utilized by the client device 115 and/or for audible speech recognition.

Client device 115 can also include one or more presence sensors 167 and/or one or more displays 169 (e.g., a touch-sensitive display). Display(s) 169 can be utilized to render streaming text transcriptions from the non-audible speech recognition engine 120 and/or can be utilized to render assistant responses generated in executing some fulfillments from on-device fulfillment engine 145. Display(s) 169 can further be one of the user interface output component(s) through which visual portion(s) of a response, from automated assistant 170, is rendered. Presence sensor(s) 167 can include, for example, a PIR and/or other passive presence sensor(s). In various implementations, one or more component(s) and/or function(s) of the automated assistant client 170 can be initiated responsive to a detection of human presence based on output from presence sensor(s) 167.

In some implementations, cloud-based automated assistant component(s) 150 can include a remote ASR engine 151 that performs speech recognition, a remote NLU engine 152 that performs natural language understanding, and/or a remote fulfillment engine 153 that generates fulfillment. A remote execution module can also optionally be included that performs remote execution based on local or remotely determined fulfillment data. Additional and/or alternative remote engines can be included. As described herein, in various implementations on-device speech processing, on-device NLU, on-device fulfillment, and/or on-device execution can also be used, for example at least due to the latency and/or network usage reductions they provide when resolving a non-audible silent speech statement (due to no client-server roundtrip(s) being needed to resolve the non-audible silent speech statement). However, one or more cloud-based automated assistant component(s) 150 can also be utilized. For example, such cloud-based component(s) can be utilized alone or in parallel with on-device component(s).

In various implementations, an NLU engine (on-device and/or remote) can generate annotated output that includes one or more annotations of the recognized text and one or more (e.g., all) of the terms of the natural language input. In some implementations an NLU engine is configured to identify and annotate various types of grammatical information in natural language input. For example, an NLU engine may include a morphological module that may separate individual words into morphemes and/or annotate the morphemes, e.g., with their classes. An NLU engine may also include a part of speech tagger configured to annotate terms with their grammatical roles. Also, for example, in some implementations an NLU engine may additionally and/or alternatively include a dependency parser configured to determine syntactic relationships between terms in natural language input.

In some implementations, an NLU engine may additionally and/or alternatively include an entity tagger configured to annotate entity references in one or more segments such as references to people (including, for instance, literary characters, celebrities, public figures, etc.), organizations, locations (real and imaginary), and so forth. In some implementations, an NLU engine may additionally and/or alternatively include a coreference resolver (not depicted) configured to group, or “cluster,” references to the same entity based on one or more contextual cues. In some implementations, one or more components of an NLU engine may rely on annotations from one or more other components of the NLU engine.

An NLU engine may also include an intent matcher that is configured to determine an intent of a user engaged in an interaction with automated assistant 195. An intent matcher can use various techniques to determine an intent of the user. In some implementations, an intent matcher may have access to one or more local and/or remote data structures that include, for instance, a plurality of mappings between grammars and responsive intents. For example, the grammars included in the mappings can be selected and/or learned over time and may represent common intents of users. For example, one grammar, “play <artist>”, may be mapped to an intent that invokes a responsive action that causes music by the <artist> to be played on the client device 160. Another grammar, “[weather|forecast] today,” may be match-able to user queries such as “what's the weather today” and “what's the forecast for today?” In addition to or instead of grammars, in some implementations, an intent matcher can employ one or more trained machine learning models, alone or in combination with one or more grammars. These trained machine learning models can be trained to identify intents, e.g., by embedding recognized text from a spoken utterance into a reduced dimensionality space, and then determining which other embeddings (and therefore, intents) are most proximate, e.g., using techniques such as Euclidean distance, cosine similarity, etc. As seen in the “play <artist>” example grammar above, some grammars have slots (e.g., <artist>) that can be filled with slot values (or “parameters”). Slot values may be determined in various ways. Often users will provide the slot values proactively. For example, for a grammar “Order me a <topping> pizza,” a user may likely speak the phrase “order me a sausage pizza,” in which case the slot <topping> is filled automatically. Other slot value(s) can be inferred based on, for example, user location, currently rendered content, user preferences, and/or other cue(s).

A fulfillment engine (local and/or remote) can be configured to receive the predicted/estimated intent that is output by an NLU engine, as well as any associated slot values and fulfill (or “resolve”) the intent. In various implementations, fulfillment (or “resolution”) of the user's intent may cause various fulfillment information (also referred to as fulfillment data) to be generated/obtained, e.g., by fulfillment engine. This can include determining local and/or remote responses (e.g., answers) to the non-audible silent speech with locally installed application(s) to perform based on the non-audible silent speech, command(s) to transmit to Internet-of-things (IoT) device(s) (directly or via corresponding remote system(s)) based on the non-audible silent speech, and/or other resolution action(s) to perform based on the non-audible silent speech. The fulfillment can then initiate local and/or remote performance/execution of the determined action(s) to resolve the non-audible silent speech.

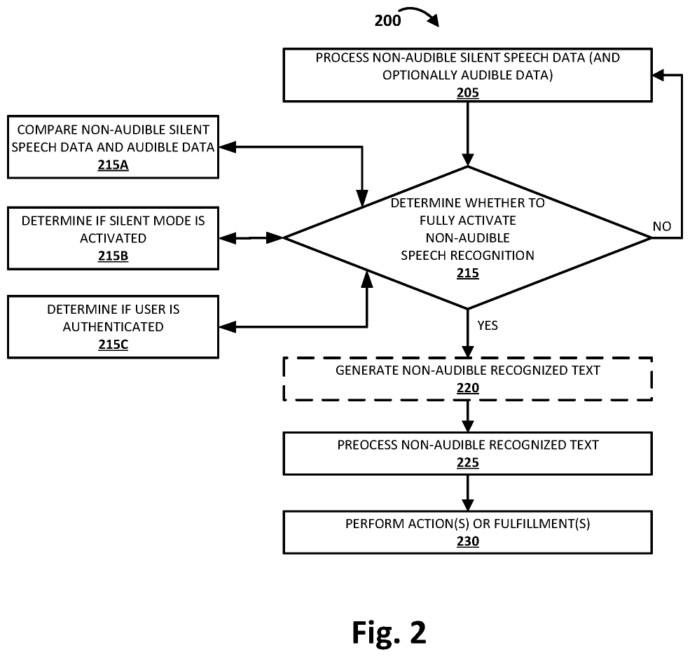

FIG. 2 depicts a flowchart illustrating an example method 200 according to implementations disclosed herein. For convenience, the operations of the method 200 are described with reference to a system that performs the operations. This system may include various components of various computer systems, such as one or more components of a client device (e.g., the client device 115 of FIG. 1). Moreover, while operations of the method 200 are shown in a particular order, this is not meant to be limiting. One or more operations may be reordered, omitted or added. As will be appreciated, the operations illustrated in FIG. 2 may correspond with various operations described herein (e.g., operations described in the Summary, and FIGS. 1A, 1B, and 2).

At block 205, the system processes non-audible silent speech data (and optionally the audible data). The non-audible silent speech data is based on information detected by one or more non-audible sensors of a client device, such as various vision components (e.g., camera(s)), Light Detection and Ranging (LIDAR) component(s), radar component(s), etc.), accelerometers, magnetometers, gyroscopes, ultrasound, and/or electromyography. The audible data, if utilized, can be based on information detected by one or more microphones of a client device. As described herein, processing non-audible silent speech data and/or audible data can include processing raw audible data and/or raw additional sensor data, and/or representation(s) and/or abstraction(s) thereof.

At block 215, based on the non-audible silent speech data (and, optionally, the audible data), the system determines whether to activate non-audible speech recognition. Determining whether to activate non-audible speech recognition 215 may include a variety of methods. In some implementations, determining whether to activate non-audible speech recognition 215 can include a determination of whether there is correspondence between the detected non-audible silent speech data and the detected audible data 215A. This determination of correspondence can include a comparison of one or more phonemes of the non-audible recognized text from the non-audible silent speech with one or more phonemes of the audible recognized text of the audible data. This determination can also, or alternatively, include a determination of if there is one or more features of a temporal correspondence between the non-audible silent speech data and the audible data. This can include, for example the start time(s) of the non-audible silent speech data and/or the audible data being within a predefined threshold; similarly, the feature(s) of temporal correspondence can include the end time(s) of the non-audible silent speech data and the audible data being within a predefined threshold. This determination can also, or alternatively, include a determination that there is a lack of correspondence based on a lack of voice activity detection based on the audible data.

In some additional or alternative implementations, determining whether to activate non-audible speech recognition 215 can include a determination of whether a silent mode is activated 215B. For example, a silent mode may automatically be activated in response to detecting that the client device is in a noisy environment or predetermined location. Silent mode can also be activated in response to detection, by the client device, of a predetermined user input.

In some additional or alternative implementations, determining whether to activate non-audible speech recognition 215 can include a determination of whether a user has been authenticated 215C (e.g., whether the user is actively utilizing the client device). This authentication can be, in some implementations, through one or more user inputs (e.g., entry of a pin, passcode, password, or the like). In additional or alternative implementations, the authentication can be through confirmation of some biometric data point (e.g., fingerprint, face scan, retinal scan, or the like). In still other implementations, the authentication can be can additionally or alternatively achieved through one or more other non-audible sensors, such as a camera, accelerometer, a magnetometer, and/or a gyroscope, which may, for example, be able to be determined by the positioning of the client device.

Regardless of how the determination to activate the non-audible silent speech recognition is made, if the decision at block 215 is no, the system continues to process non-audible silent speech data (and, optionally, the audible data) at block 205. If the decision at block 215 is yes, the system proceeds to block 220 and generates non-audible recognized text, to the extent that it was not already generated in block 215, and at block 225 processes the recognized text using the now activated non-audible speech recognition. In some implementations, the non-audible silent speech data may be processed using a trained silent model in order to generate the recognized text. Optionally, the system can also provide, via a display of the client device, a streaming transcription of the recognized text, as it is being recognized by the activated non-audible speech recognition.

At block 230, the system determines whether to perform one or more actions or initiate one or more fulfillments based on the non-audible silent speech, including determining, based on the recognized text for the non-audible silent speech data, whether to activate natural language understanding or activate fulfillment that is based on the natural language understanding. If natural language understanding is activated, one or more actions may be performed, or one or more fulfillments initiated. In some implementations, the silent speech data may be processed using a trained silent speech model to generate the recognized text. Some such requests/commands may include actions that a user wants to perform without being intrusive to others by using audible speech. For example, requests/commands such as: “stop video”, “zoom in”, “transfer call”, etc. Additionally or alternatively, one or more actions or fulfillments can include issuing a search query based on the recognized text, obtaining an answer to the search query, and causing presentation of the answer to the search query.

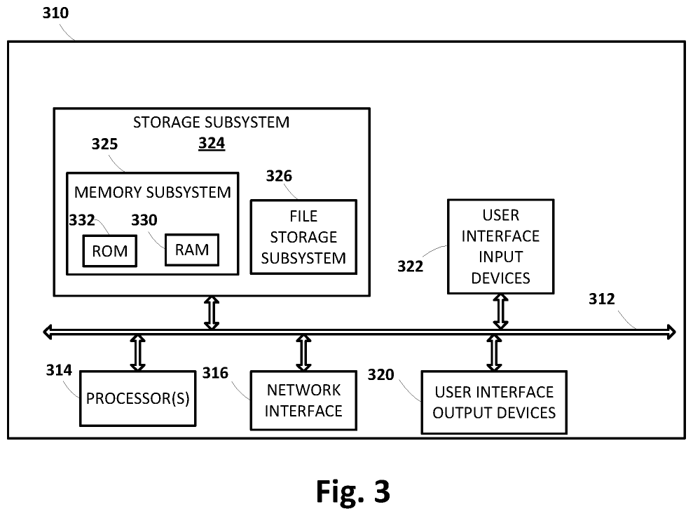

FIG. 3 is a block diagram of an example computing device 310 that may optionally be utilized to perform one or more aspects of techniques described herein. In some implementations, one or more of a client device, cloud-based automated assistant component(s), and/or other component(s) may comprise one or more components of the example computing device 310.

Computing device 310 typically includes at least one processor 314 which communicates with a number of peripheral devices via bus subsystem 312. These peripheral devices may include a storage subsystem 324, including, for example, a memory subsystem 325 and a file storage subsystem 326, user interface output devices 320, user interface input devices 322, and a network interface subsystem 316. The input and output devices allow user interaction with computing device 310. Network interface subsystem 316 provides an interface to outside networks and is coupled to corresponding interface devices in other computing devices.

User interface input devices 322 may include a keyboard, pointing devices such as a mouse, trackball, touchpad, or graphics tablet, a scanner, a touchscreen incorporated into the display, audible input devices such as voice recognition systems, microphones, and/or other types of input devices. In general, use of the term “input device” is intended to include all possible types of devices and ways to input information into computing device 310 or onto a communication network.

User interface output devices 320 may include a display subsystem, a printer, a fax machine, or non-visual displays such as audible output devices. The display subsystem may include a cathode ray tube (CRT), a flat-panel device such as a liquid crystal display (LCD), a projection device, or some other mechanism for creating a visible image. The display subsystem may also provide non-visual display such as via audible output devices. In general, use of the term “output device” is intended to include all possible types of devices and ways to output information from computing device 310 to the user or to another machine or computing device.

Storage subsystem 324 stores programming and data constructs that provide the functionality of some or all of the modules described herein. For example, the storage subsystem 324 may include the logic to perform selected aspects of the method of FIG. 2, as well as to implement various components depicted in FIGS. 1A and 1B.

These software modules are generally executed by processor 314 alone or in combination with other processors. Memory 325 used in the storage subsystem 324 can include a number of memories including a main random access memory (RAM) 330 for storage of instructions and data during program execution and a read only memory (ROM) 332 in which fixed instructions are stored. A file storage subsystem 326 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 326 in the storage subsystem 324, or in other machines accessible by the processor(s) 314.

Bus subsystem 312 provides a mechanism for letting the various components and subsystems of computing device 310 communicate with each other as intended. Although bus subsystem 312 is shown schematically as a single bus, alternative implementations of the bus subsystem may use multiple busses.

Computing device 310 can be of varying types including a workstation, server, computing cluster, blade server, server farm, or any other data processing system or computing device. Due to the ever-changing nature of computers and networks, the description of computing device 310 depicted in FIG. 3 is intended only as a specific example for purposes of illustrating some implementations. Many other configurations of computing device 310 are possible having more or fewer components than the computing device depicted in FIG. 3.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method is provided that is performed by an automated assistant application of a client device using one or more processors of the client device. The method includes detecting, at the client device, audible data based on one or more audible sensors and temporally corresponding non-audible silent speech data based on one or more non-audible sensors; determining, at the client device, whether there is correspondence between the detected non-audible silent speech data and the detected audible data; and in response to determining that there is a lack of correspondence between the detected non-audible silent speech data and the detected audible data, determining to activate one or more aspects of non-audible silent speech processing, the one or more aspects of non-audible silent speech processing including: generating recognized text based on processing the non-audible silent speech data, and/or performing one or more actions or initiating one or more fulfillments based on the recognized text generated based on the non-audible silent speech data.

In some implementations, performing one or more actions or initiating one or more fulfillments based on the non-audible silent speech data further includes: determining, based on the recognized text for the non-audible silent speech data, whether to activate natural language understanding of the recognized text and/or to activate fulfillment that is based on the natural language understanding; in response to determining to activate the natural language understanding and/or to activate the fulfillment, performing the natural language understanding and/or initiating the fulfillment.

In some implementations, the method can additionally include generating at least a portion of recognized text based on processing the non-audible silent speech data prior to determining correspondence between the detected non-audible silent speech data and the detected audible data; and generating audible recognized text based on processing the audible data prior to determining correspondence between the detected non-audible silent speech data and the detected audible data; and where the determining whether there is correspondence between the detected non-audible silent speech data and the detected audible data further includes comparing the at least a portion of recognized text with the audible recognized text. In some additional or alternative implementations wherein the one or more aspects of non-audible silent speech processing recognition includes performing one or more actions or initiating one or more fulfillments based on the recognized text generated based on the non-audible silent speech data.

In some implementations, the one or more audible sensors include a microphone of the client device. In some implementations the one or more non-audible sensors include a camera, an accelerometer, a magnetometer, and/or a gyroscope.

In some implementations, the method may additionally include determining, at the client device, whether a silent mode is activated; and wherein generating the recognized text based on processing the non-audible silent speech data occurs in response to determining that the silent mode is currently activated. In some such implementations, the method can additionally include automatically activating the silent mode in response to detecting, by the client device, that the client device is in a noisy environment. Some such implementation may include automatically activating the silent mode in response to detecting, by the client device, that the client device is in a predetermined location or activating the silent mode in response to detecting, by the client device, a predetermined user input. In some implementations, the method can additionally include providing a user with a feedback output to indicate the silent mode has been activated.

In some implementations, the method can additionally include authenticating, at the client device, a user that is actively utilizing the client device; and where generating the recognized text based on processing the non-audible silent speech data is further in response to authenticating the user. In some implementations, generating recognized text based on processing the non-audible silent speech data comprises processing the non-audible silent speech data using a trained silent model to generate the recognized text.

In some implementations, the recognized text is fully generated and processed in response to determining that there is a lack of correspondence between the detected non-audible silent speech data and the detected audible data.

In another aspect, a method implemented using one or more processors can include: authenticating, at the client device, a user that is actively utilizing the client device; in response to authenticating the user, and for a duration that the authentication of the user is active: activating on-device non-audible silent speech recognition, which includes: receiving, at the client device, non-audible silent speech data based on one or more non-audible sensors; generating recognized text based on processing the non-audible silent speech data; and performing one or more actions or initiating one or more fulfillments based on the non-audible silent speech data.

In some implementations, the authentication of the user is active while the user remains in physical contact with the client device and/or the authentication of the user is active for a predetermined period of time.

In some implementations, performing one or more actions or initiating one or more fulfillments based on the non-audible silent speech data includes: determining, based on the recognized text for the silent speech data, whether to activate on-device natural language understanding of the recognized text and/or to activate on-device fulfillment that is based on the on-device natural language understanding; when it is determined to activate the on-device natural language understanding and/or to activate the on-device fulfillment: performing the on-device natural language understanding and/or initiating, on-device, the fulfillment.

In some implementations, authenticating the user is via one or more user inputs, via one or more biometric data points, and/or via one or more non-audible sensors.

In some implementations, the one or more non-audible sensors include a camera, an accelerometer, a magnetometer, and/or a gyroscope.

In some implementations, determining to activate on-device speech recognition further comprises: receiving, at the client device, audible data based on one or more audible sensors; determining, at the client device, whether there is correspondence between the detected non-audible silent speech data and the detected audible data; and in response to determining that there is a lack of correspondence between the detected non-audible silent speech data and the detected audible data, determining to activate non-audible silent speech recognition, the non-audible silent speech recognition. In some such implementations, determining of whether there is correspondence between the detected non-audible silent speech data and the detected audible data further includes: generating audible recognized text based on processing the audible data; and wherein the determining whether there is correspondence between the detected non-audible silent speech data and the detected audible data further includes comparing one or more phonemes of the recognized text with one or more phonemes of the audible recognized text. In some additional or alternative implementations, determining whether there is correspondence between the detected non-audible silent speech data and the detected audible data further includes determining that there is a lack of correspondence based on a lack of voice activity detection based on the audible data. In some additional or alternative implementations, determining of whether there is correspondence between the detected non-audible silent speech data and the detected audible data further includes determining one or more features of a temporal correspondence between the silent speech data and the audible speech data.

In some implementations, the one or more audible sensors include one or more microphones of the client device. In some implementations, the one or more non-audible sensors include a camera, an accelerometer, a magnetometer and/or a gyroscope

In some implementations, the method can additionally include determining, at the client device, whether a silent mode is activated; and where generating the recognized text based on processing the non-audible silent speech data occurs in response to determining that silent mode is currently activated. In some such implementations, the method can additionally include automatically activating the silent mode in response to detecting, by the client device, that the client device is in a noisy environment, automatically activating the silent mode in response to detecting, by the client device, that the client device is in a predetermined location, and/or automatically activating the silent mode in response to detecting, by the client device, a predetermined user input. In some implementations, the method can additionally include providing a user with a feedback output to indicate the silent mode has been activated.

Other implementations can include one or more computer readable media (transitory and/or non-transitory) including instructions executable by one or more processors (e.g., central processing unit(s) (CPU(s)), graphics processing unit(s) (GPU(s)), and/or tensor processing unit(s) (TPU(s)) to perform a method such as one or more of the methods described above and/or elsewhere herein. Yet other implementations can include a client device having at least one microphone, at least one display, and one or more processors operable to execute stored instructions to perform a method such as one or more of the methods described above and/or elsewhere herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented using one or more processors, the method comprising:
detecting, at the client device, audible data based on one or more audible sensors and temporally corresponding non-audible silent speech data based on one or more non-audible sensors;
determining, at the client device, whether there is correspondence between the detected non-audible silent speech data and the detected audible data; and
in response to determining that there is a lack of correspondence between the detected non-audible silent speech data and the detected audible data, determining to activate one or more aspects of non-audible silent speech processing, the one or more aspects of non-audible silent speech processing including:
generating recognized text based on processing the non-audible silent speech data, and/or
performing one or more actions or initiating one or more fulfillments based on the recognized text generated based on the non-audible silent speech data.

2. The method of claim 1, wherein performing one or more actions or initiating one or more fulfillments based on the non-audible silent speech data further includes:
determining, based on the recognized text for the non-audible silent speech data, whether to activate natural language understanding of the recognized text and/or to activate fulfillment that is based on the natural language understanding; and
in response to determining to activate the natural language understanding and/or to activate the fulfillment, performing the natural language understanding and/or initiating the fulfillment.

3. The method of claim 1, further comprising:
generating at least a portion of the recognized text based on processing the non-audible silent speech data prior to determining correspondence between the detected non-audible silent speech data and the detected audible data; and
generating audible recognized text based on processing the audible data prior to determining correspondence between the detected non-audible silent speech data and the detected audible data; and
wherein the determining whether there is correspondence between the detected non-audible silent speech data and the detected audible data further includes comparing the at least a portion of the recognized text with the audible recognized text.

4. The method of claim 3, wherein the one or more aspects of non-audible silent speech processing recognition that are activated in response to determining that there is the lack of correspondence include performing one or more actions or initiating one or more fulfillments based on the recognized text generated based on the non-audible silent speech data.

5. The method of claim 1, wherein the determining whether there is correspondence between the detected non-audible silent speech data and the detected audible data further includes determining one or more features of a temporal correspondence between the non-audible silent speech data and the audible data.

6. The method of claim 1, wherein the one or more audible sensors include a microphone of the client device.

7. The method of claim 1, wherein the one or more non-audible sensors include a camera, an accelerometer, a magnetometer, and/or a gyroscope.

8. The method of claim 1 further comprising:
determining, at the client device, whether a silent mode is activated; and
wherein generating the recognized text based on processing the non-audible silent speech data occurs in response to determining that the silent mode is currently activated.

9. The method of claim 8, further comprising:
automatically activating the silent mode in response to detecting, by the client device, that the client device is in a noisy environment.

10. The method of claim 8, further comprising:
automatically activating the silent mode in response to detecting, by the client device, that the client device is in a predetermined location.

11. The method of claim 8, further comprising:
activating the silent mode in response to detecting, by the client device, a predetermined user input.

12. The method of claim 8, further comprising providing a user with a feedback output to indicate the silent mode has been activated.

13. The method of claim 1 further comprising:
authenticating, at the client device, a user that is actively utilizing the client device;
wherein generating the recognized text based on processing the non-audible silent speech data is further in response to authenticating the user.

14. The method of claim 1, wherein the generating recognized text based on processing the non-audible silent speech data comprises:
processing the non-audible silent speech data using a trained silent model to generate the recognized text.

15. The method of claim 1, wherein determining whether there is correspondence between the detected non-audible silent speech data and the detected audible data further includes determining that there is a lack of correspondence based on a lack of voice activity detection based on the audible data.

16. The method of claim 1, wherein the recognized text is fully generated and processed in response to determining that there is the lack of correspondence between the detected non-audible silent speech data and the detected audible data.

17. A method implemented using one or more processors, the method comprising:
authenticating, at a client device, a user that is actively utilizing the client device;
in response to authenticating the user, and for a duration that the authentication of the user is active:
activating non-audible silent speech recognition, which includes:
receiving, at the client device, non-audible silent speech data based on one or more non-audible sensors;
generating recognized text based on processing the non-audible silent speech data; and
performing one or more actions or initiating one or more fulfillments based on the non-audible silent speech data.

18. The method of claim 17, wherein the authentication of the user is active while the user remains in physical contact with the client device.

19. The method of claim 17, wherein the authentication of the user is active for a predetermined period of time.

20. The method of claim 17, wherein performing one or more actions or initiating one or more fulfillments based on the non-audible silent speech data includes:
determining, based on the recognized text for the silent speech data, whether to activate on-device natural language understanding of the recognized text and/or to activate on-device fulfillment that is based on the on-device natural language understanding; and
when it is determined to activate the on-device natural language understanding and/or to activate the on-device fulfillment:
performing the on-device natural language understanding and/or initiating, on-device, the fulfillment.
